(19) United States
(12) Patent Application Publication
(10) Pub. No.: US 2016/0239796 A1
(43) Pub. Date: Aug. 18, 2016

(54) SYSTEM AND METHOD FOR MONITORING MERCHANDISE IN A RETAIL ENVIRONMENT

(71) Applicant: INVUE SECURITY PRODUCTS INC.., Charlotte, NC (US)

(72) Inventors: Jeffrey A. Grant, Charlotte, NC (US); Jonathon D. Phillips, Fort Mill, SC (US)

(21) Appl. No.: 15/022,132

(22) PCT Filed: Sep. 18, 2014
(86) PCT No.: PCT/US14/56225

§ 371 Date: Mar. 15, 2016

Related U.S. Application Data
(60) Provisional application No. 61/884,098, filed on Sep. 29, 2013.

(51) Int. Cl. G06Q 10/08; G06Q 30/06

(52) U.S. Cl. CPC G06Q 10/087; G06Q 30/0641

(57) ABSTRACT

Systems and methods for monitoring items of merchandise are provided. In one example, a system includes a plurality of tags configured to be attached to a plurality of items of merchandise. The system may also include a plurality of zone managers configured to communicate wirelessly with each of the tags and a network, wherein each of the zone managers is configured to detect the proximity of at least one of the tags relative thereto. In addition, the system may include a plurality of remote devices configured to communicate wirelessly with the tags and the network, wherein one or more of the remote devices are configured to receive notifications from the network regarding the tags.

### CROSS REFERENCE TO RELATED APPLICATIONS

The present application claims the benefit of the filing date of U.S. Provisional Application No. 61/884,098, filed on Sep. 29, 2013, the disclosure of which is incorporated herein by reference in its entity.

### BACKGROUND OF THE INVENTION

Embodiments of the present invention relate generally to merchandise security, including systems and methods for monitoring merchandise in a retail environment.

It is common practice for retailers to provide demonstration models of consumer electronics products, such as handheld devices, tablets, and laptop computers, so that a potential purchaser may examine the product more closely and test the operation of its features. A working demonstration model, however, increases the possibility that the demonstration model will be stolen or removed from the display area by an unauthorized person. As a result, demonstration models of consumer electronics products are typically protected by a security device that permits a potential purchaser to examine and operate the product, while reducing the likelihood that the demonstration model or a removable component of the product will be stolen or removed from the display area. Some security devices are cumbersome and limit the ability of the consumer to fully appreciate the features of the product.

Moreover, many boxed items of merchandise are secured with alarming wraps or cables, or are enclosed in locked cabinets that may hinder a customer's ability to fully appreciate the product.

In addition, most retailers focus predominantly on security rather than using its sales associates to facilitate merchandise sales. Oftentimes, security takes away from the customer experience and does not encourage engagement of the sales associate to facilitate a sale.

### BRIEF SUMMARY

Embodiments of the present invention are directed to methods and systems for monitoring items of merchandise. In one embodiment, a method comprises attaching a plurality of tags to a plurality of items of merchandise, wherein at least one of the tags is attached to each of the items of merchandise. Each of the tags is configured to communicate wirelessly with a network and a plurality of remote devices. The method further includes positioning each of the items of merchandise within one of a plurality of detection zones, wherein each detection zone defines a location for communicating with a plurality of tags. The method also includes receiving notification at one or more of the remote devices for each tagged item of merchandise positioned within a detection zone, as well as registering each of the tagged items of merchandise positioned within a detection zone with one of the remote devices so as to associate each tagged item of merchandise with the tag. In addition, the method includes receiving notification at one or more of the remote devices when a customer interacts with a registered, tagged item of merchandise.

In another embodiment, a method includes notifying a plurality of remote devices when each of a plurality of tagged items of merchandise is positioned in a detection zone, wherein the proximity of each of the tagged items of merchandise is configured to be wirelessly monitored within the detection zone. The method also includes notifying one or more of the remote devices when a customer interacts with one of the tagged items of merchandise.

According to another embodiment, a method includes receiving notification over a network that at least one item of merchandise is located within a detection zone, wherein the at least one item of merchandise comprises at least one tag attached thereto. The method also includes registering the tagged item of merchandise located within the detection zone so as to associate the item of merchandise with the tag and receiving notification over the network when a customer interacts with the registered item of merchandise.

In another embodiment, a system includes a plurality of tags, wherein one or more tags are configured to be attached to a respective one of a plurality of items of merchandise. The system further includes a plurality of zone managers configured to communicate wirelessly with each of the tags and a network, wherein each of the zone managers is configured to detect the proximity of at least one of the tags relative thereto. Moreover, the system includes a plurality of remote devices configured to communicate wirelessly with each of the tags and the network, wherein each of the remote devices is configured to receive notifications from the network regarding each of the tags.

### BRIEF DESCRIPTION OF THE DRAWINGS

The detailed description of the invention provided below may be better understood with reference to the accompanying drawing figures, which depict one or more embodiments of methods and systems for monitoring and securing items of merchandise from theft.

FIG. 1 illustrates a system for monitoring and securing items of merchandise from theft according to one embodiment of the invention.

FIG. 2 illustrates a method for monitoring and securing items of merchandise from theft according to one embodiment of the invention.

FIG. 3 illustrates a method for securing items of merchandise from theft according to one embodiment of the invention.

FIG. 4 illustrates a schematic of a tag configured to be attached to an item of merchandise according to one embodiment of the invention.

FIG. 5 shows an example of a detection zone according to one embodiment of the invention.

FIG. 6 shows an example of an item of merchandise in communication with a tag according to one embodiment of the invention.

FIG. 7 shows an example of a tag disengaged from a carrier according to one embodiment of the invention.

FIG. 8 shows an example of a zone manager within a detection zone according to one embodiment of the invention.

FIGS. 9 and 10 illustrate locking hooks according to one embodiment of the present invention.

### DETAILED DESCRIPTION OF EMBODIMENTS OF THE INVENTION

Referring to the accompanying figures wherein identical reference numerals denote the same elements throughout the various views, the illustrated embodiments of methods and systems according to the present invention are capable of not only protecting an item of merchandise against theft or unauthorized removal, but also for monitoring merchandise in a retail environment. The item of merchandise 12 may be any item, including any number of consumer electronics products (e.g. hand-held device, cellular phone, smart phone, tablet, laptop computer, etc.). In addition, the items of merchandise 12 may be packaged (or boxed) or non-packaged items. The system, indicated generally at 10, is operable for monitoring items of merchandise 12 and permitting a potential purchaser to examine an item of merchandise. Although described in relation for use in a retail environment, the system 10 shown and described herein is suitable for monitoring and securing an item of merchandise 12 in other settings, such as for example, a residential or commercial environment, and furthermore, is not intended to be limited to use only as a system for protecting against theft and/or unauthorized removal.

According to one embodiment, the system 10 generally comprises a plurality of tags 14 configured to be coupled to one or more items of merchandise 12. The system 10 also includes a plurality of zone managers 16 that are configured to communicate with one or more tags 14. Each of the zone managers 16 defines a detection zone 18 that corresponds to a predetermined proximity to the zone manager. The zone managers 16 are configured to detect the proximity of one or more tags 14 thereto as explained in further detail below. The system 10 further includes a plurality of remote devices 20 configured to communicate with each of the zone managers 16. The remote devices 20 may be used by, for example, a sales associate in a retail environment. The system 10 may also include at least one door guard 22 that is configured to communicate with the tags 14 and remote devices 20. The door guard 22 could be positioned near an exit of a retail store in one embodiment. The tags 14, zone managers 16, remote devices 20, and/or door guards 22 may be in communication with one another and over a network 24. In one example, the communication is entirely wireless, and the network 14 could be a cloud-based network. As also explained in further detail below, customers 26 may interact within the system 10, such as by interacting with a tagged item of merchandise and/or by communicating with a tag 14 via a mobile device 28 (e.g., a cellular phone or smartphone).

As will become more apparent below, embodiments of the present invention may provide several benefits. For example, the system 10 provides an emphasis on engaging the sales associate to effectuate a sale as well as provide security benefits. In particular, by providing the sales associate with various notifications, the sales associate is motivated to assist a customer 26 and is kept abreast of customer interaction with items of merchandise 12. In a way, the increased interaction between the sales associate and the customer 26 also provides security since the sales associate will be notified when various events affecting the item of merchandise 12 occur. In fact, studies have shown, such as by the LPRC (Loss Prevention Research Council), that the “engagement level” of associates is a major contributing factor in the effectiveness of theft deterrence. As such, the awareness of the sales associate will be increased thereby prompting the associate to be more alert as to various customer 26 interactions and actions.

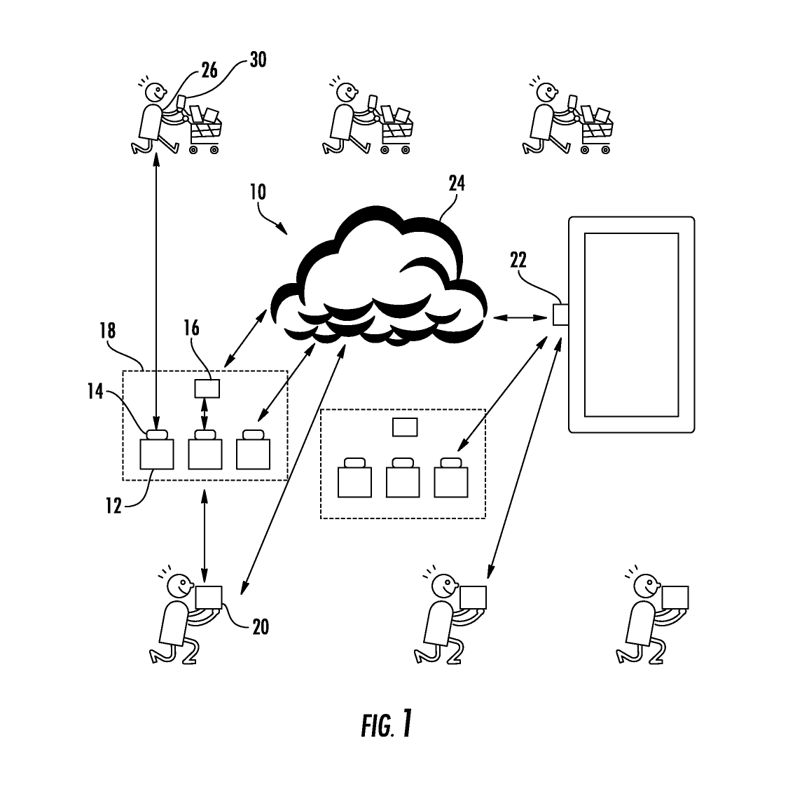

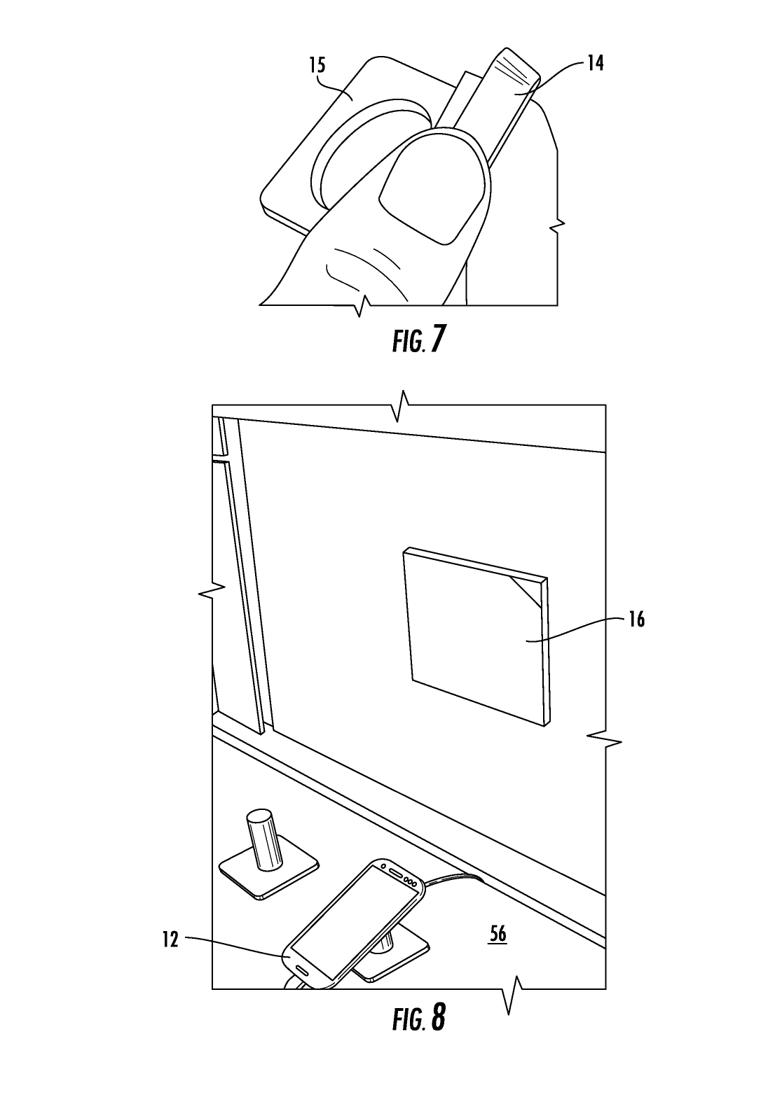

In one embodiment, FIG. 1 shows that one tag 14 is attached to a respective item of merchandise 12, although more than one tag can be attached to an item of merchandise if desired. The tags 14 may be coupled to items of merchandise 12 using any suitable technique, such as with an adhesive, cables, and the like. For example, FIG. 7 shows that a tag 14 may be attached to a carrier 15 that is secured to an item of merchandise 12. Thus, the tag 14 may be removable and reusable. The carrier 15 may be attached to the item of merchandise 12 and may or may not be removed after a purchase of the item of merchandise is made.

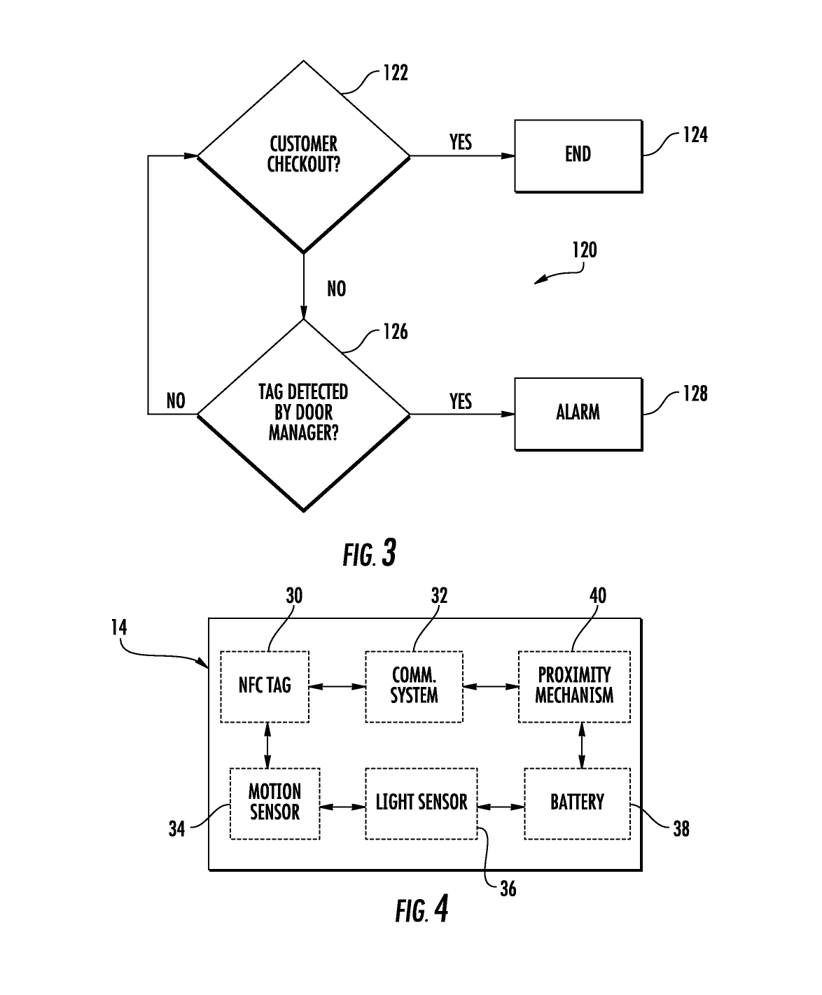

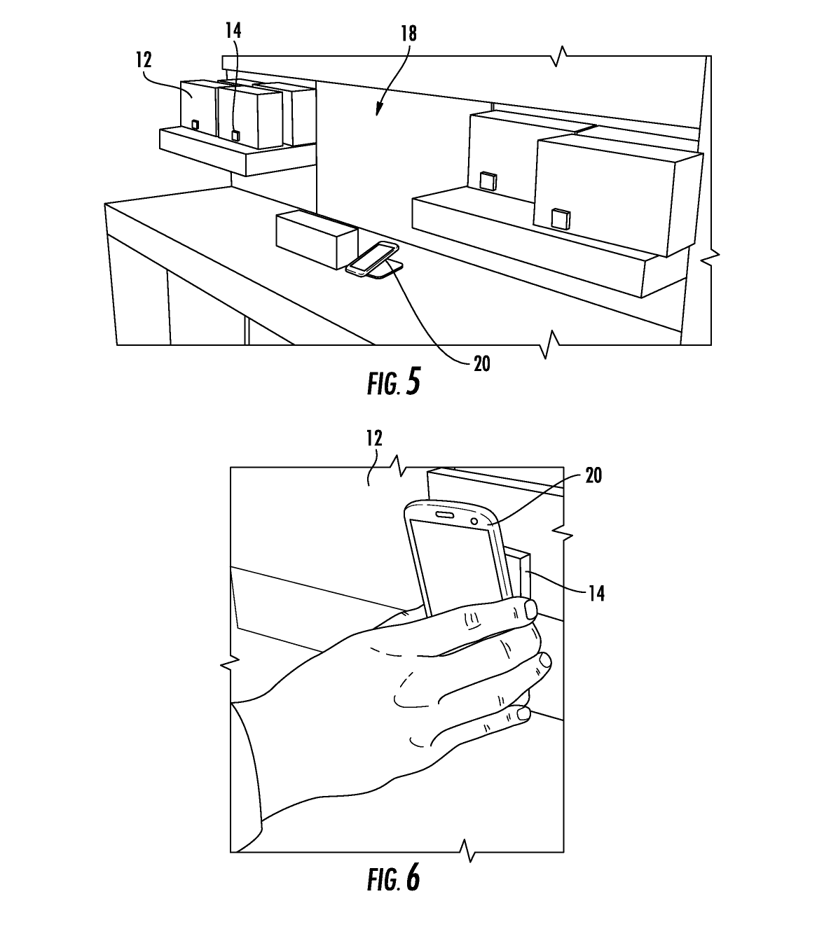

In addition, FIG. 4 shows that a tag 14 may include a variety of components. For example, a tag 14 may include a near field communication (“NFC”) tag 30 configured to communicate with a remote device or a customer's mobile device 28. In addition, a tag 14 may include a communication system 32 for communicating with a zone manager 18, a remote device 20, a door guard 22, a customer mobile device 28, and/or the network 24. For instance, the communication system 32 may be configured for wireless communication using any desired communications protocol, such as Bluetooth communication, Bluetooth low energy communication, WiFi, cellular, received signal strength indicator (“RSSI”), and/or ambient backscatter. In some embodiments, the tags 14 may be configured to communicate with one another via respective communication systems 32. For example, the tags 14 may communicate with one another to transmit or relay signals to a zone manager 18 and/or the network 24. In some cases, communication between one tag 14 and a remote device 20 may be relayed to a zone manager 18, another remote device 20, and/or the network via one or more other tags. Thus, the tags 14 may be configured to communicate with one another and other components within the system 10. In one instance, the number of zone managers 18 may be reduced where tags 14 are capable of communicating with one another since a signal that may not otherwise reach the zone manager may be relayed to the zone manager via one or more additional tags.

Where the tag 14 includes NFC functionality, it is understood that the NFC tag 30 may be read only or editable. Thus, the tag 14 may include a “bi-directional” NFC tag 30 so as to also have the ability to be updated with new characteristics or instructions by an associate's remote device 20 so that when a customer's mobile device 28 interacts with the tag, the tag exhibits a different behavior than before. For example, the associate could use their remote device 20 to “program” the tag 14 to instruct the customer's mobile device 28 to go to website address “X” if he or she were to touch his or her mobile device near or on the tag. And then the associate at a later time could come back to that tag 14 and reprogram it to instruct the next future customer's mobile device 28 to go to website address “Y”, etc.

Furthermore, a tag 14 may include a motion sensor 34 for detecting motion of the tag and/or a light sensor 36 for detecting a change in light level. Thus, the tag 14 may be configured to detect a change in motion and/or light level which may be indicative of theft of the item of merchandise 12. The tag 14 may also include a battery 38 or power source for powering any of the aforementioned components, although a battery may not be necessary in some embodiments. For example, the tag 14 may only include passive devices that are configured to be energized by another device. In one embodiment, the tag 14 also includes a proximity mechanism 40 that is configured to detect whether the tag is attached to the item of merchandise 12 or removed from the item of merchandise. For example, the proximity mechanism 40 may be a pressure or plunger switch that is configured to detect when the tag 14 has been removed by an unauthorized person. Should such an unauthorized removal be detected, the tag 14 may be configured to alarm or communicate with the zone manager 16, door guard 22, and/or network 24 to take appropriate action.

It is understood that the tag 14 may have any desired size and configuration suitable for attachment to an item of merchandise 12. For example, the tag 14 may include a housing with a low profile that does not take away from the presentation of the item of merchandise 12. In addition, the tag 14 may be configured to be stackable with other tags for storage when not in use. In some embodiments, the tags 14 are reusable such that the tags may be removed by a sales associate or at a checkout counter and reused on another item of merchandise 12. In the case where the tag 14 includes a battery 38, the battery may be rechargeable and could be recharged while the tags are stacked on top of one another (e.g. via contact charging).

In some embodiments, each of the zone managers 16 is configured to communicate wirelessly with one or more tags 14 and the network 24. Thus, the zone manager 16 may include a communication system configured to communicate with the tag's 14 communication system 34. In some embodiments, each zone manager 16 may be configured to communicate with the tags 14, remote devices 20, door guard 22, and/or network 24. As noted above, communications may take place using a variety of techniques, including wirelessly via Bluetooth or Bluetooth low energy communications. In one embodiment, each of the zone managers 16 is configured to detect the proximity of one or more tags 14 thereto. Thus, each of the zone managers 16 may define a detection zone 18. The detection zone 18 may be a location that is defined based on a particular “home” position of a zone manager 16 and may be defined based on a particular distance, volume, or area relative to the home position. The detection zone 18 may be defined based on a signal strength of the zone manager 16 such that only tags 14 detected by the zone manager or having a minimum signal strength will be considered positioned within the detection zone. For example, where a tag 14 has been attached to item of merchandise 12, placing the tagged item within the detection zone 18 allows the zone manager 16 to detect the tag and to allow the tag and the zone manager to communicate with one another. There may be any number of zone managers 16 provided in order to accommodate any number of items of merchandise 12 for a desired retail space or product line. For example, each detection zone 18 could be associated with a particular product line (e.g., televisions, speakers, cameras, etc.).

The zone manager 16 may be any suitable device that is configured to facilitate communication with a plurality of tags 14, remote devices 20, and/or network 24. For example, a zone manager 16 may be secured to, or positioned at, any desired location to establish a detection zone 18 for items of merchandise 12. FIG. 8 shows one example of a zone manager 16 attached to a rear support adjacent to a display shelf. In addition, each zone manager 16 may be secured in, or positioned at, locations that may not otherwise be visible to customers 26 and could be placed, for instance, on the ceiling, walls, and/or behind or below a counter, panel, or cabinet of a retail store. In the example shown in FIG. 8, a panel may be positioned in front of the zone manager 16 so that the zone manager is not visible to customers.

In one embodiment, a plurality of remote devices 20 are configured to communicate wirelessly with each of the tags 14, zone managers 16, door guards 22, and/or the network 24. The remote device 20 may be any suitable device, such as a tablet, mobile phone, camera phone, smartphone, or the like. As noted above, each remote device 20 could be used by a sales associate, and each sales associate may be assigned a remote device. Thus, the remote device 20 may be a mobile device used as a sales tool to receive notifications from the zone managers 16, door guard 22, and/or network 24. In some embodiments, a remote device 20 may be associated with a particular detection zone 18. For example, a detection zone 18 may be associated with a remote device 20 that is configured to communicate with tags 14 attached to items of merchandise 12 within the detection zone. The remote device 20 could also be the same item of merchandise 12 that is being offered for sale within the detection zone 18, or the remote device could be configured to operate with the item of merchandise that is for sale in the detection zone. The remote devices 20 may also store or be able to provide information regarding items of merchandise 12. In some embodiments, the remote devices 20 are configured to communicate with the tags 14 to exchange information. For instance, a remote device 20 may be configured to provide data regarding an item of merchandise 12 when the remote device communicates with a tag. In addition, the remote device 20 may be configured to communicate with a zone manager 16 to receive notifications when a tagged item of merchandise 12 has been positioned within a detection zone 18. The remote device 20 could also receive notification from the zone manager 16 and/or network 24 when a customer 26 interacts with a tagged item of merchandise 12. Further, the remote device 20 may be configured to receive notification from a door guard 22 when a tagged item of merchandise 12 is approaching the door guard or is within a predetermined distance from the door guard.

In one embodiment, the door guard 22 may be positioned proximate to an exit of a retail establishment. Any number of door guards 22 may be employed to accommodate any number of exits or locations to protect items of merchandise 12 from theft. Each door guard 22 may include a communication system configured to communicate with the tags 14, zone managers 16, remote devices 20, door guard 22, and/or network 24. As discussed above, any desired communications protocol may be used, including any wireless communications protocol. The door guard 22 may be configured to provide notification to the remote devices 20 and/or network 24 when a tagged item of merchandise 12 is proximate thereto. For example, the door guard 22 may be configured to provide notification when a tagged item of merchandise 12 is within a predetermined distance, and should the distance continue to decrease, the door guard may be configured to generate an alarm signal (e.g., a visual and/or audible alarm). The door guard 22 could utilize the signal strength between the tagged item of merchandise 12 and the door guard to determine whether to provide notification and/or an alarm signal. Thus, should the signal strength become too strong or greater than a predetermined signal strength, the door guard 22 may be configured to generate an alarm signal.

It is understood that the door guard 22 may be any suitable device that is configured to facilitate communication with a plurality of tags 14, remote devices 20, and/or network 24. For example, a door guard 22 may be secured to, or positioned near, any desired location to prevent theft of items of merchandise. In addition, the door guard 22 may be secured in, or positioned at, locations that may not otherwise be visible to customers 26 and could be placed, for instance, on the ceiling, walls, and/or doorways or exits of a retail store.

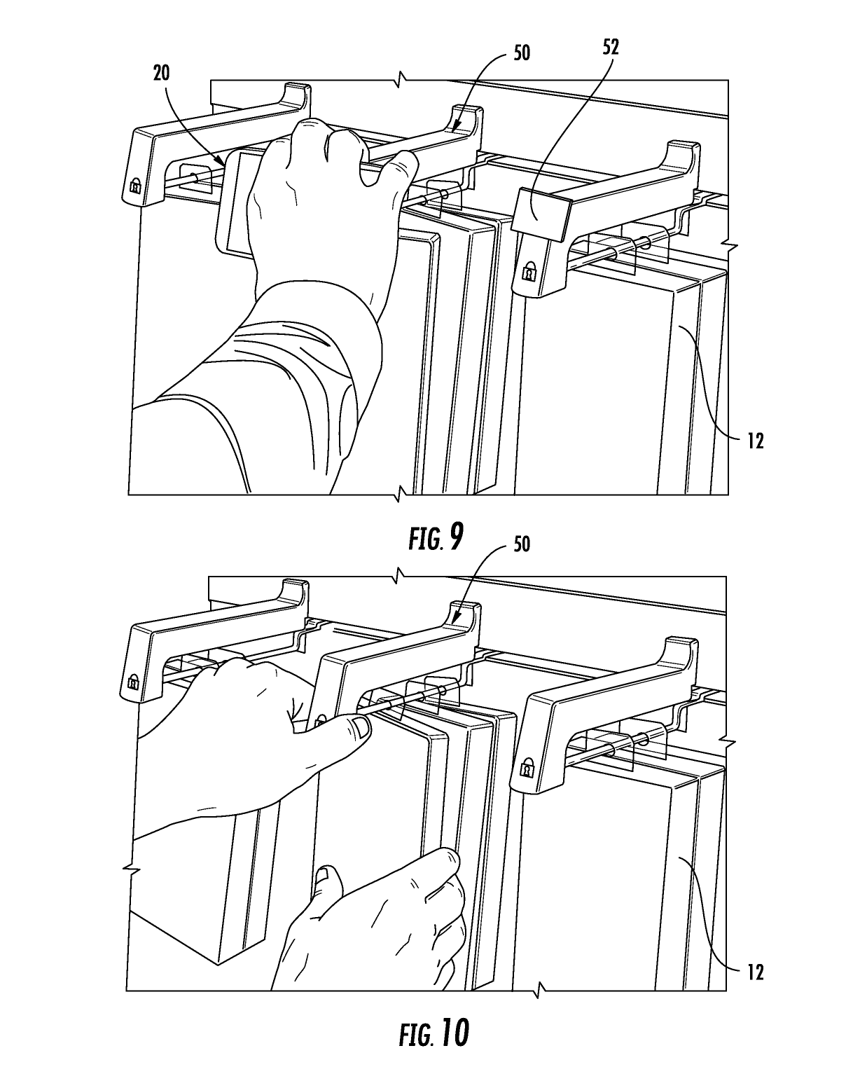

In some embodiments, items of merchandise 12 may be configured to be displayed on one or more locking hooks 50 (see, e.g., FIGS. 9 and 10). The locking hook 50 may be configured to interact with remote devices 20 and customer's mobile devices 28. The locking hook 50 is configured to releasably engage at least one elongate rod, bar, or the like. In the illustrated embodiment, the locking hook 50 is configured to engage a pair of rods disposed generally parallel to one another. Items of merchandise 12 may be disposed on the lower rod. The locking hook 50 is configured to move between locked and unlocked configurations through engagement and disengagement with the lower rod with a lock mechanism. The lock mechanism could utilize electrical and/or mechanical functionality to facilitate engagement and disengagement with the rod. The locking hook 50 generally includes a housing that is coupled to the upper rod. The locking hook may include a controller, power source, communications circuitry, and/or at least one NFC tag.

The locking hook 50 may include NFC functionality that is configured to communicate with a remote device 20 or mobile device 28 having NFC functionality. As shown in FIG. 9, a sales associate may utilize a remote device 20 having NFC functionality to interact with a locking hook 50. FIG. 10 shows that the locking hook 50 has been unlocked following communication between the remote device 20 and the NFC tag of the locking hook 50. An authorized sales associate is then able to remove items of merchandise 12 from the rod.

In one embodiment, the looking hook 50 may include an NFC read/writable tag that is embedded in the physical platen that forms a price label holder 52. An associate can “program” the NFC tag locally with their NFC enabled remote device 20 using an application on the remote device. A customer 26 may then use their own mobile device 28 to obtain product information for the item of merchandise 12 displayed on the locking hook, such as using a mobile device with NFC functionality. In another embodiment, a customer 26 may be able to interact with the locking hook label. For example, the looking hook label may include an integrated screen (e.g., a touch sensitive IPT (intelligent price label)) so that when the associate programs the NFC tag with their remote device 20, the label enables customers 26 to view the pricing information as the standard screen, but is configured to also provide the option for the customer to swipe or otherwise physically interact with the label screen with his or her finger to obtain additional information about the item of merchandise. After an amount of time of no activity, the label screen may be configured to default back to the standard price label view.

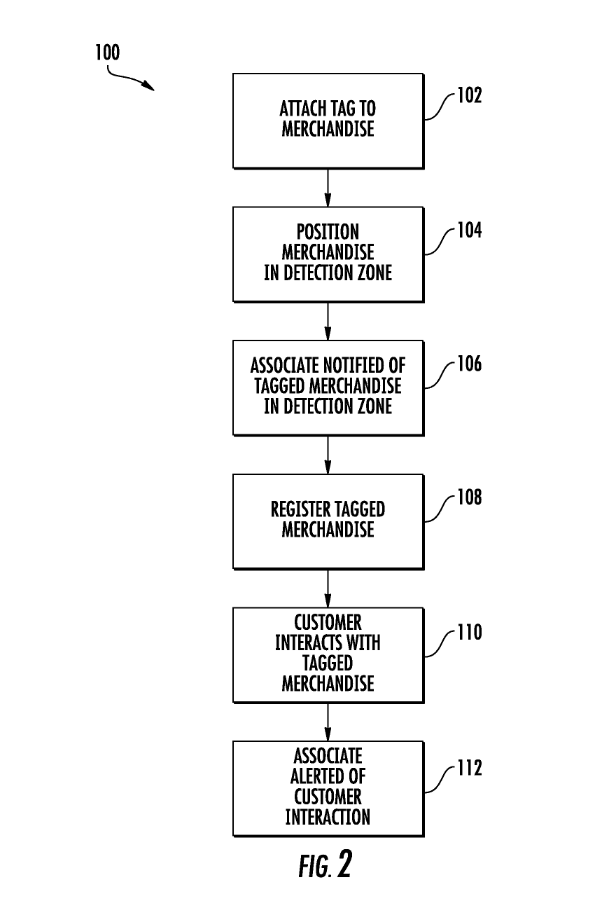

Various methods may be employed for monitoring items of merchandise 12 and for providing security from theft according to embodiments of the present invention. With reference to FIG. 2, one embodiment of such a method 100 is illustrated. The method according to this example includes attaching a plurality of tags 14 to a respective one of a plurality of items of merchandise 12 (block 102). Each of the tags 14 may be configured to communicate wirelessly with a network 24 and a plurality of remote devices 20. The method may further include positioning each of the tagged items of merchandise 12 in one of a plurality of detection zones 18 (block 104). For example, a retail associate may attach a tag 14 to an item of merchandise 12 and then position the tagged item in the detection zone 18. Or, the retail associate could tag the item of merchandise 12 in the detection zone 18. Where a tag 14 is positioned within more than one detection zone 18, the zone manager 16 and/or network 24 may be configured to pick one detection zone for association with the tag (e.g., the zone manager with the stronger signal). When positioned within a detection zone 18, the tag 14 and associated zone manager 16 may be paired with one another (e.g., via Bluetooth communication).

Once positioned in a detection zone 18, one or more remote devices 20 may be notified via the zone manager 16 and/or network 24 that a tagged item of merchandise 12 has been positioned in a detection zone (block 106). In this case, a retail associate may be required to register the tag 14 (block 108). However, in some embodiments, the tag 14 may be registered automatically, such as via communication with the item of merchandise 12, the zone manager 16, and/or the network 24. Registration may be used to associate the tag 14 with an item of merchandise 12. In one example, the first sales associate to respond to the notification may scan his or her remote device 20 proximate to the tag 14 to communicate therewith (e.g., via NFC). By registering the tag 14, the tag is associated with the item of merchandise 12, which can in turn be communicated to the zone manager 16 and/or network 24 for tracking.

In one embodiment, where the tag 14 includes NFC functionality, the tag may include a unique identifier for identifying the tag. For example, the tag 14 may include an NFC tag, where the tag identifies a unique ID for the tag itself. In one example, the remote device 20 may include a camera, and the item of merchandise 12 may include a bar code. When a sales associate uses his or her remote device's 20 camera to scan the barcode of the item of merchandise 12, the barcode is associated with the NFC tag's ID. The associate could also use the remote device's 20 camera to take a representative photo of the packaged item of merchandise 12. All of this information may be combined in a cloud of the network 24 so as to be associated with a record of the item of merchandise 12 for future notification.

In one embodiment, the network 24 may be configured to monitor and store information regarding the tag 14 and the item of merchandise 12. In addition, the network 24 may be configured to monitor various data associated with the item of merchandise 12, such as for example, a number of pick ups of an item of merchandise 12, sales trends, related items of merchandise that are likely to be sold together, a stolen or misplaced item of merchandise, etc.

Once the tag 14 is registered, the zone manager 16 can monitor for customer 26 interaction with the item of merchandise 12 (block 110). For example, the zone manager 16 may be configured to detect when a customer 26 has picked up an item of merchandise 12. Alternatively, the tag 14 may be configured to detect movement (e.g., via a motion sensor) and notify the remote devices 20, the zone manager 16, and/or the network 24 of such customer interaction. Customer interaction may also be indicative of a customer 26 scanning the tag 14 with the customer's mobile device 28 (e.g., via NFC). When a customer interacts with an item of merchandise 12, the remote devices 20 may be notified of the same (block 112). For example, the zone manager 16 and/or network 24 may provide notification to one or more remote devices 20 of the interaction, which prompts the sales associates to approach the customer 26. For example, notification may be simultaneously broadcasted to a plurality of sales associates. Once a sales associate responds to the notification, the sales associate may be given a predetermined period of time to engage the customer 26 (e.g., 5-20 seconds) before the notification is again rebroadcast to all sales associates. The sales associate could scan the tag 14 with a remote device 20 to provide information regarding the item of merchandise 12, as well as similar related items of merchandise. In one embodiment, the act of scanning the tag 14 is also the means that the associate “proves” to the network 24 that he or she followed up on the notification. In other words, scanning the tag 14 may prove physical proximity to the tag that was reported to be on the move based on feedback from its zone manager 16. In addition, information regarding the item of merchandise 12 may be provided to the customer's mobile device 28 when the tag 14 is scanned by the customer. In some cases, the sales associate could utilize the remote device 20 to complete a sale.

Once a customer 26 has a tagged item of merchandise 12 in hand, such interaction may also be monitored. For example, FIG. 3 illustrates a method 120 for monitoring customer 26 interaction when a tagged item of merchandise 12 is outside of its detection zone 18, which may be used to provide security from theft. In this instance, where the customer 26 intends to purchase the item of merchandise 12, such as at a checkout counter, no additional notifications may occur (blocks 122 and 124). However, where the customer 26 is a potential thief, the tag 14 may be configured to detect changes in motion and/or light level, which may be indicative of an attempted theft. For example, where the tag 14 is moving and senses a reduction in light level, the item of merchandise 12 may be secured from view by the potential thief (e.g., placed in a bag). In this example, the tag 14 may be configured to generate an audible and/or visible alarm signal. In addition, the lack of communication (or a sharp decrease in signal strength) between the tag 14 and the zone manager 16 may also be detected, which also causes an alarm signal to be generated by the tag and/or door guard 22. Moreover, an attempted unauthorized removal of the tag 14 may be detected, which may also result in an alarm signal being generated. If the potential thief approaches a door guard 22, the door guard may be configured to detect the tag 14 (block 126). The door guard 22 may simply provide an initial reminder for the customer 26 to approach a checkout counter (e.g., via generation of an alarm signal by the door guard and/or the tag 14). Should the signal strength of the tag 14 continue to increase with respect to the door guard 22, the door guard may be configured to generate an alarm signal (block 128), as well as notify the network 24. The door guard 22 may be configured to generate an alarm signal that escalates in volume and/or frequency as the tag 14 gets closer to the door guard. Furthermore, each of the remote devices 20 may receive an alert when one of the tagged items of merchandise 12 is detected within a predetermined distance from a door guard 22. Thus, a sales associate may be alerted of a potential thief, which allows a sales associate to approach the thief to potentially rectify the situation.

In some embodiments, the natural mode of detecting tags 14 may be too “strong” or too “omni-directional” and thereby have the tendency to cause false alarms or limit placement of items of merchandise 12 too close to the door guard 22 for fear of false alarm. One example solution is to implement a “directional antennae” and/or an artificial clamping/suppressing of the signal through RF absorptive/reflective material that would thereby focus the direction/plane of detection to a narrower aperture that more closely maps to the opening of the door itself and/or a zone directly in front of the door.

The method depicted in FIG. 2 and described above represents only one method for monitoring and securing items of merchandise from theft. Similarly, the method depicted in FIG. 3 and described above represents only one method for securing an item of merchandise from theft. In some embodiments, certain ones of the steps described above may be modified or further amplified. Furthermore, in some embodiments, additional optional steps may be included. Modifications, additions, or amplifications to the steps above may be performed in any order and in any combination. The particular methods will depend on the numbers and types of merchandise, the retail environment, the type of communication protocols employed between tags, zone managers, door guards, and/or the network, and/or other considerations.

The foregoing has described one or more embodiments of a system and method for monitoring and securing item of merchandises from theft or unauthorized removal. Although embodiments of the present invention have been shown and described, it will be apparent to those skilled in the art that various modifications thereto can be made without departing from the spirit and scope of the invention. Accordingly, the foregoing description is provided for the purpose of illustration only, and not for the purpose of limitation.

1. A method for monitoring items of merchandise, the method comprising:
attaching a plurality of tags to a plurality of items of merchandise, at least one of the tags attached to each of the items of merchandise, each of the tags configured to communicate wirelessly with a network and a plurality of remote devices;
positioning each of the items of merchandise within one of a plurality of detection zones, each detection zone defining a location for communicating with a plurality of tags;
receiving notification at one or more of the remote devices for each tagged item of merchandise positioned within a detection zone;
registering each of the tagged items of merchandise positioned within a detection zone with one of the remote devices so as to associate each tagged item of merchandise with the tag; and
receiving notification at one or more of the remote devices when a customer interacts with a registered, tagged item of merchandise.

2. The method of claim 1, further comprising receiving an alert at one or more of the remote devices when one of the tagged items of merchandise is outside of its detection zone.

3. The method of claim 1, wherein positioning comprises positioning each of the items of merchandise within a predetermined distance from a zone manager within a detection zone, each of the zone managers configured to detect a proximity of each of the tags thereto.

4. (canceled)

5. A method for monitoring items of merchandise, the method comprising:
receiving notification over a network that at least one item of merchandise is located within a detection zone, the at least one item of merchandise comprising at least one tag attached thereto;
registering the tagged item of merchandise located within the detection zone so as to associate the item of merchandise with the tag; and
receiving notification over the network when a customer interacts with the registered item of merchandise.

6. The method of claim 5, further comprising receiving an alert when the tagged item of merchandise is outside of the detection zone and is detected within a predetermined distance from a door guard.

7. The method of claim 5, further comprising communicating with the tag such that information regarding the item of merchandise is obtained.

8. The method of claim 7, further comprising displaying the information regarding the item of merchandise.

9. A system for monitoring items of merchandise, the system comprising:
a plurality of tags, one or more tags configured to be attached to a respective one of a plurality of items of merchandise;
a plurality of zone managers configured to communicate wirelessly with each of the tags and a network, each of the zone managers configured to detect the proximity of at least one of the tags relative thereto; and
a plurality of remote devices configured to communicate wirelessly with each of the tags and the network, each of the remote devices configured to receive notifications from the network regarding each of the tags.

10. The system of claim 9, further comprising at least one door guard configured to wirelessly communicate with one or more of the tags, each of the remote devices, and/or the network.

11. The system of claim 10, wherein the at least one door guard is configured to generate an alarm signal when a tag is within a predetermined distance thereof.

12. The system of claim 9, wherein each of the tags comprises a communication system configured to communicate wirelessly with a customer's mobile device to provide information regarding an item of merchandise.

13. The system of claim 9, wherein each of the tags comprises a near field communication tag configured to communicate with the remote devices via near field communication.

14. The system of claim 9, wherein each of the tags comprises a near field communication tag configured to communicate with a customer's mobile device via near field communication.

15. The system of claim 9, wherein each of the tags comprises a pressure switch configured to detect an unauthorized removal of the tag from an item of merchandise.

16. The system of claim 9, wherein each of the tags comprises a motion sensor configured to detect motion of the tag.

17. The system of claim 9, wherein each of the tags comprises a light sensor configured to detect a reduction in light.

18. The system of claim 9, wherein each of the tags comprises an adhesive for attachment to an item of merchandise.

19. The system of claim 9, wherein each of the zone managers is configured to be paired with each of the tags positioned within a respective detection zone.

20. The system of claim 19, wherein each of the zone managers is configured to be paired with each of the tags via Bluetooth communication.
